(19) United States
(12) Patent Application Publication
(10) Pub. No.: US 2004/0080635 A1
(43) Pub. Date: Apr. 29, 2004

(54) Charge coupled device (CCD) camera having a correction function for defective CCDS and a correction method

(76) Inventor: Sung-Bin Hong, Yongin-City (KR)

Correspondence Address: Mark W. Hrozenchik, Roylance, Abrams, Berdo & Goodman, L.L.P., Suite 600, 1300 19th Street, N.W., Washington, DC, 20036, US

(21) Appl. No.: 10/662,478

(22) Filed: Sep. 16, 2003

(30) Foreign Application Priority Data
Oct. 28, 2002 (KR) 2002-65846

(51) Int. Cl. H04N 5/217

(52) U.S. Cl. 348/247

(57) ABSTRACT

Disclosed is a CCD camera having a correction function for determining defective CCDs. A CCD camera periodically drives a shutter through a shutter driving unit at a low speed. If light is incident on a CCD module with the driving of the shutter at the low speed, photo-electrically converted signals outputted from individual CCDs are sequentially stored in a memory. The electric signals of the CCDs stored in the memory are read out, amplified by a predetermined level, and compared to a CCD defect threshold level. If the signals from the CCD devices are larger than the CCD defect threshold level, location information of the CCD devices having signals larger than the CCD defect threshold level is stored in the memory. Further, when the captured signals are scanned, average electric signals of adjacent CCD devices are scanned for the electric signals of the CCD devices larger than the threshold level based on the location information stored in the memory.

This application claims benefit under 35 U.S.C. § 119 from Korean Patent Application No. 2002-65846, filed on Oct. 28, 2002, the entire content of which is incorporated herein by reference.

### BACKGROUND OF THE INVENTION

1. Field of the Invention

The present invention relates to a camera, and more particularly to a charge coupled device (CCD) camera using charge coupled devices to capture images of subjects and a control method therefor.

2. Description of the Related Art

A CCD camera is a device designed to acquire subject images. A CCD camera uses charge coupled devices (CCDs) to change optical brightness into electrical amplitude signals. This allows even distant images to be reproduced, without picture degradation and without exposure time limitations. Accordingly, the CCDs are a significant component of the CCD camera. As a result, CCD manufacturers and purchasers are engaged in diverse research and development to eliminate and overcome the deficiencies of CCDs.

However, not all deficiencies of CCDs are manufacturing related. For example, damage to the CCDs can be due to diverse external disturbances such as ultraviolet and gamma rays, local environmental conditions, and so on. These deficiencies can occur during distribution of the CCDs even though no defects occurred in the manufacturing process. As a result, it is not easy to determine suitable measures to counteract such deficiencies to the CCD in the manufacturing process. Additionally, the CCDs may be damaged due to high temperatures and the like which occur during the use of a CCD camera. As a result, it is necessary to correct the damage or defects caused by the environment within which the CCD camera is used.

Accordingly, in order to correct the defects of the CCDs in a conventional CCD camera, coordinates from defective CCDs are stored in a memory by opening the iris to expose the photosensitive part to light for a certain period of time (assuming that the power is initially on), and detecting a signal obtained from each of the CCDs by the exposure. Furthermore, based on position information recorded in the memory, signals from defective pixels can be substituted or replaced with signals from pixels adjacent to the defective ones, when scanning signals for a captured image.

As discussed above, the CCD camera replaces signals from defective CCDs with signals from adjacent CCDs to provide good quality images even though the CCD camera has one or more defective CCDs.

However, conventional methods for correcting defective CCDs detect defective CCDs only for a certain period of time following the initial application of electric power. Therefore, appropriate compensations are not provided for CCDs having defects due to heat and dark current during use of a CCD camera. This leads to the loss of users' confidence in the product and can lead to the exchange of the CCD module itself, which unnecessarily causes a waste of resources.

### SUMMARY OF THE INVENTION

An object of the present invention is to substantially solve at least the above problems and/or disadvantages and to provide at least the advantages described below. Accordingly, it is an object of the present invention to provide a CCD camera and a control method capable of compensating for defective CCDs occurring during the use of the CCD camera.

In order to achieve the above and other objects, an embodiment of the present invention provides a CCD camera which comprises a shutter for adjusting incident light for a specific amount of time; a shutter driving unit for driving the shutter; a CCD module formed with a plurality of CCDs outputting electric signals based on an amount of light incident through the shutter; a memory for storing electric signals provided by the respective CCDs of the CCD module; and a control unit for controlling operation of the CCD camera. The control unit will control the CCD camera, if electric power is supplied, by periodically driving the shutter through the shutter driving unit, sequentially storing in the memory photo-electrically converted signals with respect to the individual CCDs of the CCD module, comparing the respective CCD signals stored in the memory to a preset CCD defect threshold level to detect location information on CCDs that output signals larger than the CCD defect threshold level, and replacing each of the respective signals from the CCDs that output signals larger than the CCD defect threshold level with a respective average signal representing an average of the signals output by CCDs adjacent to the respective CCDs that output the larger signals, based on the location information.

The control unit controls the shutter driving unit to operate the shutter at a low speed. Further, the control unit controls the shutter driving unit to operate the shutter at the low speed in a predetermined interval by a vertical period of the CCD data. Further, the control unit controls the shutter driving unit to alternately operate the shutter in odd fields and even fields of the CCDs at the low speed.

More particularly, the control unit amplifies the electric signals of the individual CCDs read out of the memory to a certain level and compares the amplified electric signals to the CCD defect threshold level, and arranges and stores in a second region of the memory in a descending order of signal values, the location information of the CCDs having electric signals larger than the CCD defect threshold level. The CCD camera further comprises a second memory for storing the location information of defective CCDs. The control unit compares the electric signals of the individual CCDs to the CCD defect threshold level, and arranges and stores in the second memory in a descending order of signal values the location information of the CCDs having electric signals larger than the CCD defect threshold level.

In order to achieve the above identified and other objects of the invention, a method for controlling the CCD camera comprises the steps of periodically exposing CCDs to light for a predetermined period of time; sequentially storing electric signals of individual CCDs based on the exposure; sequentially reading out the stored electric signals of the individual CCDs and comparing the electric signals to a preset CCD defect threshold level; storing location information of CCDs having electric signals larger than the CCD defect threshold level as a result of the comparison; and replacing signals from the CCDs for which the location information is stored with signals from adjacent CCDs based on the location information, when the stored electric signals of the CCD devices are scanned, to scan average electric signals of the adjacent CCDs.

In accordance with an embodiment of the present invention, the exposure is carried out by driving an electronic shutter at a low speed, and the driving of the shutter at the low speed is alternately carried out in odd fields and even fields in a predetermined interval by a vertical period of CCD data.

The step for comparing the electric signals of the individual CCDs to the CCD defect threshold level includes the steps of amplifying the electric signals of the individual CCDs devices and comparing the amplified electric signals of the CCDs to the CCD defect threshold level. Furthermore, the control method comprises the step of arranging in a descending order of signal values the location information on the CCDs having electric signals larger than the CCD defect threshold level, after comparing the electric signals of the individual CCD devices to the CCD defect threshold level.

The CCD camera and the control method as described above operate to detect and correct small defects within the CCDs so as to enhance the reliability of products such as cameras employing the CCDS. This prevents wasting of resources since CCD modules unable to be used due to defects can otherwise be used.

### BRIEF DESCRIPTION OF THE DRAWINGS

The novel features believed characteristic of the invention are set forth in the appended claims. The invention itself, however, as well as other features and advantages thereof will be best understood by reference to the detailed description of the embodiments which follows, when read in conjunction with the accompanying drawings, in which:

FIG. 1 is a block diagram schematically showing an example of a CCD camera according to an embodiment of the present invention;

FIG. 2 is a flow chart for explaining an example of a method for correcting defective CCDs in the CCD camera shown in FIG. 1; and

FIG. 3 is a view for showing illustrative shutter driving periods based on FIG. 2.

### DETAILED DESCRIPTION OF THE PREFERRED EMBODIMENTS

Several embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein have been omitted for conciseness.

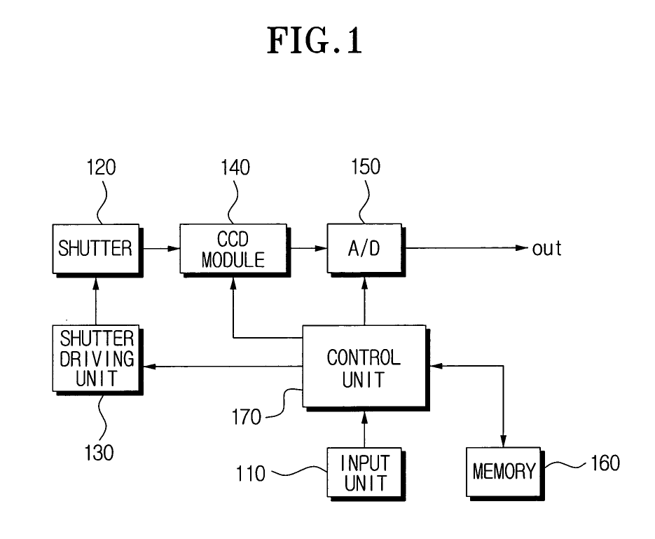

FIG. 1 is a block diagram for schematically showing a CCD camera according to an embodiment of the present invention. A CCD camera includes an input unit 110, a shutter 120, a shutter driving unit 130, a CCD module 140, an A/D converter 150, a memory 160, and a control unit 170.

Each of the elements of the CCD camera will be briefly described. The input unit 110 transmits to the control unit 170 user's CCD camera operation commands through a plurality of operation keys. Shutter 120 adjusts the amount of incident light with respect to time. Shutter driving unit 130 drives the shutter 120 under the controls of the control unit 170. CCD module 140 has a plurality of CCDs in a suitable arrangement, and outputs electric signals based on incident light through the shutter 120. A/D converter 150 converts electric analog signals outputted from the CCD module 140 into digital signals. Memory 170 stores digital signals provided by the A/D converter 150 for individual CCDs.

As described in greater detail below, the control unit 170 controls the overall operations of the CCD camera, detects in particular locations of CCDs having small defects, and enables corrected signals to be scanned for defective CCD devices when scanning electric signals corresponding to individual CCD devices based on the detected location information.

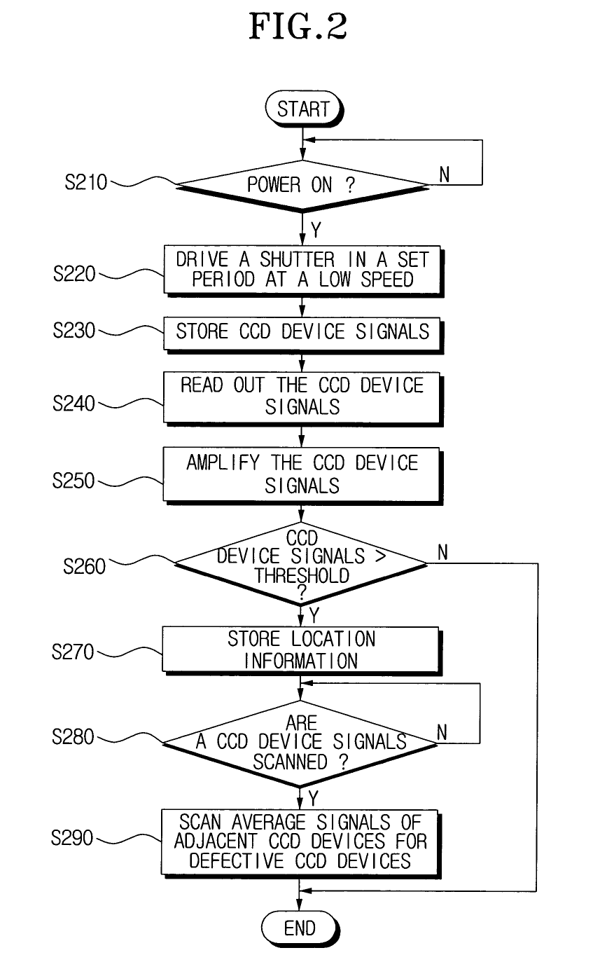

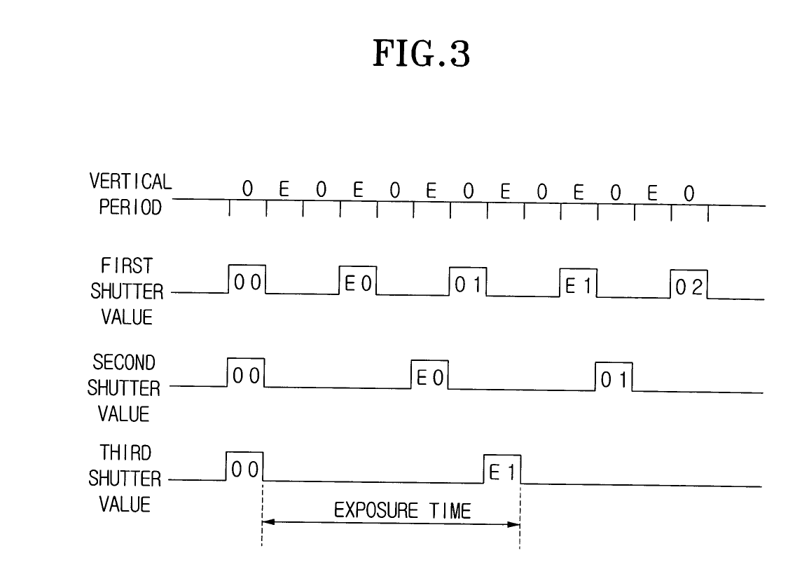

FIG. 2 is a flow chart that describes an example of a method in accordance with an embodiment of the invention for compensating for defective CCDs of a CCD camera. The method described in FIG. 2 begins by determining whether power has been applied by a user through the input unit 110 in step 210 (S210). In step 220, the control unit 170 periodically drives the shutter 120 through the shutter driving unit 130 (S220). The control unit 170 controls the shutter driving unit 130 to operate the shutter at a low speed. Further, the control unit controls the shutter driving unit 130 to alternately drive the shutter 120 in odd fields and even fields. FIG. 3 shows illustrative shutter driving periods. If light is incident on the CCD module 140 as the shutter operates at the low speed as discussed above, individual CCDs output photo-electrically converted signals. In step 230, the control unit 170 enables the photo-electrically converted signals of the individual CCDs to be sequentially stored in the memory 160 (S230). Thereafter, in step 240, the control unit 170 reads out the respective electric signals of the CCDs stored in the memory 160 (S240), amplifies the electric signals output from the CCDs stored in the memory 160 by a certain gain level in step 250 (S250), and compares the read-out signals to a preset CCD defect threshold level in decision step 260 (S260).

Then, in decision step 260, the control unit 170 compares the amplified electric signals to the CCD defect level. If the electric signals output from the CCDs are larger than the CCD threshold level (“Yes” path from decision step 260), the control unit 170 stores, in a second region of the memory 160, location information of the CCDs having signals larger than the CCD defect threshold level in step 270(S270). An electrical signal from a CCD greater than the CCD defect level indicates a defective CCD.

The control unit 170 arranges and stores in the memory 160 the electric signals of the CCDs larger than the CCD defect threshold level in a descending order. In decision step 280, the control unit 170 verifies whether CCDs are being scanned (S280). In step 290 (“Yes” path from decision step 280), the control unit 170 scans an average electric signal from the CCDs adjacent to the defect-detected CCD based on the location information stored in the memory 160, instead of an electric signal of the defect-detected CCD device (S290).

A CCD camera employing the above described method for detecting defective CCDs periodically operates at low speed to detect defective CCDs. The CCD camera can then detect and correct defects not discovered during initial quality checks. As a result, the CCD camera amplifies signals that are generated by heat and dark currents within the camera itself, and compares the amplified levels to the CCD defect threshold level so that it can detect and correct even tiny defects.

As described above, a CCD camera and method for correction of signals from defective CCDs according to certain embodiments of the present invention can detect and correct defects upon power-up as well as during use of the camera. This enables the CCD camera to provide high-quality images to users even though the CCD module may have a plurality of defective CCDs. Thus, wasting of resources is prevented.

While the invention has been shown and described with reference to certain embodiments thereof, it will be understood by those skilled in the art that various changes in form and details may be made therein without departing from the spirit and scope of the invention as defined by the appended claims.

What is claimed is:

1. A charge coupled device (CCD) camera that compensates for defective CCDs, comprising
a shutter, adapted to adjust incident light for a specific amount of time;
a shutter driving unit, adapted to drive the shutter;
a CCD module, comprising a plurality of CCDs that are adapted to output electric signals based on an amount of light incident through the shutter;
a memory, adapted to store electric signals provided by the respective CCDs transmitted from the CCD module; and
a control unit, adapted to perform the following operations:
control the shutter driving unit to periodically drive the shutter;
sequentially storing in the memory photo-electrically converted signals with respect to the individual CCDs of the CCD module;
comparing the respective CCD signals stored in the memory to a preset CCD defect threshold level to detect location information of CCDs that output signals larger than the CCD defect threshold level; and
replacing each of the respective signals from the CCDs that output signals larger than the CCD defect threshold level with a respective average signal representing an average of the signals output by the CCDs adjacent to the respective CCDs that output the larger signals based on the location information.

2. The CCD camera according to claim 1, wherein the control unit is adapted to control the shutter driving unit to operate the shutter at a low speed.

3 The CCD camera according to claim 1, wherein the control unit is adapted to control the shutter driving unit to operate the shutter at a low speed in a predetermined interval based on a vertical period of the CCD data.

4. The CCD camera according to claim 1, wherein the control unit is adapted to control the shutter driving unit to alternately operate the shutter in odd fields and even fields of the CCDs at the low speed.

5. The CCD camera according to claim 1, wherein:
during the comparing operation, the control unit amplifies the electric signals of the individual CCDs read out of the memory to a certain level and compares the amplified electric signals to the CCD defect threshold level;
durign the comparing operation, the control unit compares the electric signals of the individual CCDs to the CCD defect threshold level; and
during the replacing operation, the control unit arranges and stores in a second region of the memory at a descending order of signal values the location information relating to the CCDs having electric signals larger than the CCD defect threshold level.

6. The CCD camera according to claim 1 further comprising:
a second memory, adapted to store the location information of defective CCDs, wherein during the comparing operation, the control unit compares the electric signals of the individual CCDs to the CCD defect threshold level, and during the replaying operation the control unit arranges and stores in the second memory at a descending order of signal values the location information relating to the CCDs having electric signals larger than the CCD defect threshold level.

7. A method for controlling a CCD camera to correct for defective CCDs, comprising:
exposing CCDs periodically to light for a predetermined amount of time;
sequentially storing electric signals of individual CCDs based on the exposure;
sequentially reading out the stored electric signals of the individual CCDs;
comparing the electric signals to a preset CCD defect threshold level;
storing location information relating to CCDs having electric signals larger than the CCD defect threshold level as a result of the comparison; and
replacing each of the individual signals from the CCDs for which the location information is stored, with an average signal representing an average of the signals output by the CCDs adjacent to the individual CCDs based on the location information.

8. The method according to claim 7, wherein the step of comparing comprises:
amplifying the electric signals of the individual CCDs; and
comparing the amplified electric signals of the CCDs to the CCD defect threshold level.

9. The method according to claim 7, further comprising:
arranging in a descending order of signal values the location information relating to the CCDs having electric signals larger than the CCD defect threshold level, after comparing the electric signals of the individual CCD devices to the CCD defect threshold level.

10. The method according to claim 9, wherein:
the storing step comprises storing the arranged signal values arranged in the arranging step.
